(19) United States
(12) Patent Application Publication
(10) Pub. No.: US 2012/0019841 A1
(43) Pub. Date: Jan. 26, 2012

(54) DOCUMENT SCANNER

(76) Inventors: David M. Schaertel, Webster, NY (US); Daniel P. Phinney, Rochester, NY (US); George A. Hadgis, Spencerport, NY (US); Bruce A. Holroyd, Rochester, NY (US); Bruce A. Link, Rochester, NY (US); James A. Oliver, Webster, NY (US); Marybeth Schmidt, Rush, NY (US); Roland Simonis, Evanston, IL (US); Swapnil Sakharshete, Rochester, NY (US); Carl J. Tesavis, Spencerport, NY (US); Robert M. Westcott, Holley, NY (US); Donald C. Kurdt, Fairport, NY (US)

(21) Appl. No.: 12/839,471

(22) Filed: Jul. 20, 2010

(51) Int. Cl. H04N 1/60; G06K 15/00; H04N 1/40

(52) U.S. Cl. 358/1.9; 358/448; 358/449; 358/1.14

(57) ABSTRACT

A document scanner (10) includes an input tray (20) for holding documents (11); an input image capture device (30) for capturing images of documents in the input tray; an image processor for determining characteristics of documents; and the documents are processed based on the characteristics.

### CROSS REFERENCE TO RELATED APPLICATIONS

Reference is made to commonly-assigned copending U.S. patent application Ser. No. ______ (Attorney Docket No. 96442/NAB), filed herewith, entitled METHOD FOR DOCUMENT SCANNING, by Schaertel et al.; the disclosure of which is incorporated herein.

### FIELD OF THE INVENTION

This invention relates to extracting properties of the document fed to a scanner from an input tray, before the document passes scanning cameras on a transport path.

### BACKGROUND OF THE INVENTION

A document scanner moves a document through a transport path and creates an image of the document as it moves. The processor memory for the document scanner must have preset document characteristics and the operator must select functions and features to accommodate the specific requirements for a particular document. Alternately, the scanner may default to less efficient settings that will process all documents since scanners are not typically programmed with specific requirements on a document-by-document basis.

The preset characteristics, features, and functions are a product of document characteristics, such as size, weight, texture, and specific application requirements such as resolution, imaging mode; for example color, simplex, or duplex. In a document scanner, the documents to be scanned may vary by size, weight, color content, physical condition, or other characteristics, which may require different scanner features to be enabled or operator actions to be employed, for the most optimal and efficient mode of operation. Prior knowledge of these many different document attributes can enable the proper selection of scanner features to improve the efficiency of the scanning process or enable other features which may provide specific applications required by a particular type, style, or size of document.

Prior knowledge of the documents physical condition can also prompt immediate action from the operator to protect the document or scanner or allow other features within the scanner to perform more reliably. There is a need, therefore, for detection of document characteristics prior to the document entering transport path.

### SUMMARY OF THE INVENTION

Briefly, according to one aspect of the present invention a document scanner includes an input tray for holding documents; an input image capture device for capturing images of documents in the input tray; an image processor for determining characteristics of documents; and the documents are processed based on the characteristics.

The invention and its objects and advantages will become more apparent in the detailed description of the preferred embodiment presented below.

### BRIEF DESCRIPTION OF THE DRAWINGS

FIG. 1 is a cross-section view from the side of a document scanner which illustrates the various parts of the scanner related to the present invention.

FIG. 2 is a perspective view of the scanner and illustrates various types of documents.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

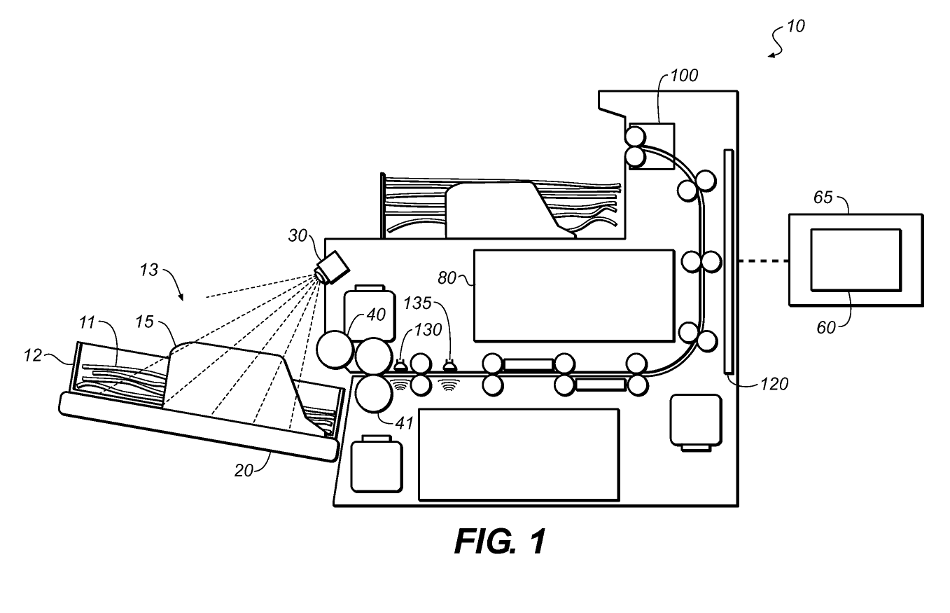

FIG. 1 is a side cross-sectional view of a document scanner 10. The illustration shows the input tray 20 and input tray camera or image capture device 30. A typical scanner also has a transport mechanism for moving documents through the scanner and an output tray for collecting documents as well as other components that makeup a document scanner.

As shown in FIG. 1, documents 11 are first placed in the input tray 20 of the scanner. Imaging capture device 30 captures an image of the top document on the stack of documents 11. The document image is captured both statically and dynamically as it begins to move forward into the scanner by the feed roller 40 and separation roller 41. As frames of image data are captured, they are transmitted to be processed by an image processor shown schematically as image processing block 60.

The image processing block 60 processes the image data, to determine document characteristics such as document content, document condition, the desired information to be extracted and saved from the document. These characteristics will enable a particular feature or operation of the scanner based on the document content or condition. The document is processed based on the document characteristics.

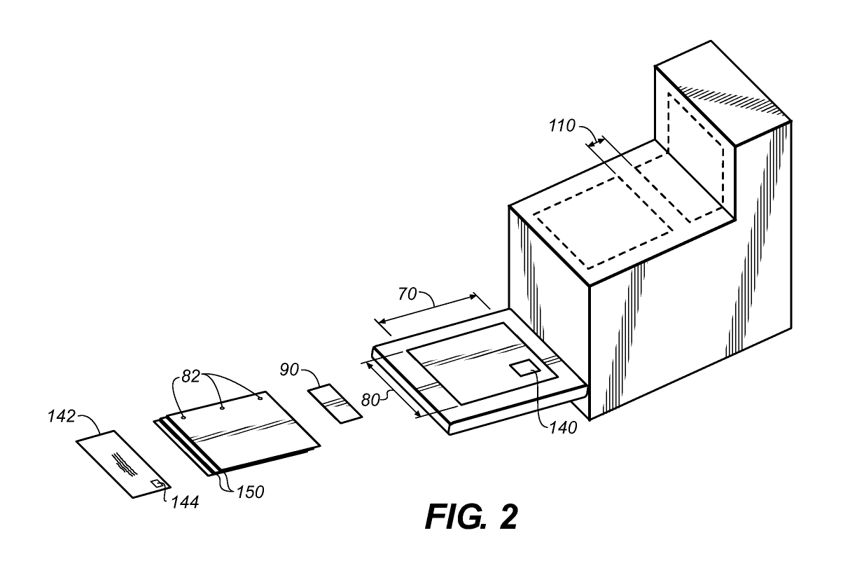

Some of the document characteristics that are important in processing the document is the document length 70 or width 80 shown in FIG. 2. If a short document is detected the master image buffer (not shown) size is reduced. If a short document is detected the feed roller 40 may also be stopped to prevent jams. For a longer document, the feed roller continues to run which will reduce feed roller wear.

Another scanner feature related to length and width includes sorting the document on exit from the scanner. For example, if the document is a check 90. The document may also be checked for compatibility with the scanner. Controlled output stacking 100 shown in FIG. 1 may be adjusted for higher throughput, or a document gap 110 may be adjusted according to document length.

An important document characteristic is orientation. Detection of the document orientation as portrait or landscape, relative to the direction of document travel, will be used to improve the performance of the auto orientation feature. Using document width or location of the document in the input tray 20, is used to improve the document locate function.

Color or lack thereof within a document will be determined to set the appropriate color mode for image capture. Stick on labels 140 are detected based on color. The results are used to disable ultrasonic sensing in the area of the label.

Content within the document will be used for line or form detection. This enables the processor 65 to determine whether to capture the image or not and what processing may be required for the image data if captured. Patches and barcodes will be detected and read for the processor to take the appropriate action. Detection of postage stamps 144 or envelopes 142 is used by the processor to adjust scanner operation.

Document content is processed using optical character recognition (OCR) to detect a predetermined word, detect and interpret magnetic character ink, photographs, text or graphics. The processor then modifies scanner functions, for example, disabling automatic orientation when no text is present. Money may also be detected and counted.

Document content is also used to detect checks 90 and document resolution. The processor uses this information to adjust scanner functions such as setting the image capture mode.

A document characteristic useful for scanner processing is a folded corner or torn portion of the document. If those defects are detected the transport will be stopped and the operator will be alerted to this condition. Holes 82 in the document will be detected by the input image capture device 30 and ignored by the machine control function 120 of the scanner. Wrinkles in the document, if detected, causes processor to optimized parameters for sonic 130 or ultrasonic 135 detection. Another detectable characteristic is a staple, paperclip, or rubber band on the document. When detected the processor stops the transport and the operator is alerted of the condition. Tape located on a document may be detected and is a possible indication of a fraudulent document.

Imaging of the input tray 20 area detects the presence of documents 11 or a batch box 12. Once documents are detected, the number of documents can be determined. The absence of documents in the input tray will be detected. Orientation or location of the documents detected indicates document skew and location. This information enhances the performance of automatic orientation.

The transport may be stopped and the operator altered to conditions that adversely affect operation of the scanner.

Imaging of the documents 11 will be used to detect dual shadows 150 which may indicate a multi-feed. No movement of the documents may indicate a misfeed.

Imaging of the input area 13 and processing of the image data will determine characteristics of the input area whereby side guide 15 location can be determined. Correct side guide location will be determined with regard to the documents 11 in the input tray 20.

The invention has been described in detail with particular reference to certain preferred embodiments thereof, but it will be understood that variations and modifications can be effected within the scope of the invention.

### PARTS LIST

10 scanner
11 documents
12 batch box
13 input area
15 side guide
20 input tray
30 imaging capture device
40 feed roller
41 separation roller
60 image processing block
65 processor
70 document length
80 document width
82 holes
90 check
100 controlled output stacking
110 document gap
120 machine control function
130 sonic detection
135 ultrasonic detection
140 stick on label
142 envelope
144 postage stamp
150 dual shadows

1. A document scanner comprising:
an input tray for holding documents;
an input image capture device for capturing images of documents in the input tray;
an image processor for determining characteristics of documents; and
wherein said documents are processed based on said characteristics.

2. The document scanner as in claim 1 wherein at least one characteristic is document length or width.

3. The document scanner as in claim 2 wherein a master image buffer is reduced for short documents.

4. The document scanner as in claim 2 wherein a feed roller is stopped on detection of short documents to prevent jams.

5. The document scanner as in claim 2 wherein document exit sorting is modified on detection of a check.

6. The document scanner as in claim 2 wherein document characteristics are checked for compatibility with the scanner.

7. The document scanner as in claim 2 wherein dynamic controlled output stacking is adjusted based on said characteristics for higher throughput.

8. The document scanner as in claim 2 wherein an inter-document gap is adjusted according to document length.

9. The document scanner as in claim 2 wherein the document orientation with regard to portrait or landscape is detected.

10. The document scanner as in claim 9 wherein the scanning mode is adjusted to improve the performance of auto orientation.

11. The document scanner as in claim 2 wherein the document locate function performance is improved.

12. The document scanner as in claim 1 wherein at least one characteristic is document color or tone.

13. The document scanner as in claim 12 wherein the document color content, or lack thereof, is used by the scanner application to select an appropriate color mode for image capture.

14. The document scanner as in claim 12 wherein stick-on label detection is based on color.

15. The document scanner as in claim 14 wherein detection of a stick-on label can be used by an ultrasonic sensors to ignore that area of the document.

16. The document scanner as in claim 1 wherein at least one characteristic is document content.

17. The document scanner as in claim 16 wherein document content provides form identification, or line detection, to determine whether to capture the image data or not.

18. The document scanner as in claim 16 wherein document content is used to detect or read a patch.

19. The document scanner as in claim 16 wherein document content is used to detect or read a barcode.

20. The document scanner as in claim 16 wherein document content is used to detect a postage stamp.

21. The document scanner as in claim 16 wherein document content is used to detect an envelope.

22. The document scanner as in claim 16 wherein document content is processed using optical character recognition (OCR) to detect a predetermined word.

23. The document scanner as in claim 16 wherein document content is used to detect and interpret magnetic ink character recognition (MICR).

24. The document scanner as in claim 16 wherein document content is used to detect photographs, text, or graphics.

25. The document scanner as in claim 24 wherein automatic orientation is disabled if no text is present.

26. The document scanner as in claim 16 wherein document content is used to detect money.

27. The document scanner as in claim 26 wherein document content is used to count money.

28. The document scanner as in claim 16 wherein document content is used to detect checks.

29. The document scanner as in claim 16 wherein document content is used to detect document resolution characteristics.

30. The document scanner as in claim 29 wherein a scanner mode is selected based on the detected resolution.

31. The document scanner as in claim 1 wherein at least one characteristic is a folded corner.

32. The document scanner as in claim 1 wherein at least one characteristic is a hole in the document.

33. The document scanner as in claim 32 wherein at least one characteristic is hole size in the document.

34. The document scanner as in claim 32 wherein the hole size is communicated to a machine control function of the scanner so that the hole is ignored.

35. The document scanner as in claim 1 wherein at least one characteristic is paper tears.

36. The document scanner as in claim 35 wherein the scanning mode stops the transport and alert an operator.

37. The document scanner as in claim 1 wherein at least one characteristic is a wrinkle in the document.

38. The document scanner as in claim 37 wherein ultrasonic parameters are optimized on detection of a wrinkle.

39. The document scanner as in claim 37 wherein sonic jam detection parameters are optimized on detection of a wrinkle.

40. The document scanner as in claim 1 wherein said characteristic is a staple, paperclip, or rubber band.

41. The document scanner as in claim 1 wherein at least one characteristic is presence of the document.

42. The document scanner as in claim 1 wherein at least one characteristic is presence of a batch box.

43. The document scanner as in claim 1 wherein at least one characteristic is number of documents in the input tray.

44. The document scanner as in claim 1 wherein at least one characteristic is absence of documents in the input tray.

45. The document scanner as in claim 1 wherein at least one characteristic is document orientation.

46. The document scanner as in claim 45 wherein document skew angle is detected.

47. The document scanner as in claim 46 wherein the scanning mode can be setup to stop the transport and alert the operator of this condition.

48. The document scanner as in claim 1 wherein at least one characteristic is document location in the input tray.

49. The document scanner as in claim 48 wherein the scanning mode is setup to improve performance of auto orientation.

50. The document scanner as in claim 1 wherein at least one characteristic is document movement.

51. The document scanner as in claim 50 wherein lack of document movement indicates a misfeed.

52. The document scanner as in claim 51 wherein document movement of two or more documents together causes moving shadows.

53. The document scanner as in claim 52 wherein moving shadows within a document indicates a multi-feed.

54. The document scanner as in claim 1 wherein at least one characteristic is tape on a document for fraud detection.

55. A document scanner comprising:
an input tray for holding documents;
an input image capture device for capturing images of the input tray;
an image processor for determining characteristics of the input tray; and
wherein input tray characteristics are processed and scanner control will be based on said characteristics.

56. The document scanner as in claim 55 wherein at least one characteristic is Side guide location.

57. The document scanner as in claim 56 wherein scanner control is based on side guide location.
